(19) United States
(12) Patent Application Publication
(10) Pub. No.: US 2024/0066737 A1
(43) Pub. Date: Feb. 29, 2024

(54) CUTTING APPARATUS AND METHOD FOR CUTTING CAPS

(71) Applicant: SACMI COOPERATIVA MECCANICI IMOLA SOCIETA’ COOPERATIVA, Imola (BO) (IT)

(72) Inventors: Davide PENAZZI, Imola (BO) (IT); Matteo VENTURINI, Imola (BO) (IT)

(21) Appl. No.: 18/261,173

(22) PCT Filed: Jan. 21, 2022
(86) PCT No.: PCT/IB2022/050500

§ 371 Date: Jul. 12, 2023

(30) Foreign Application Priority Data
Jan. 22, 2021 (IT) 102021000001118

(51) Int. Cl. B26D 1/03; B26D 3/06; B26D 7/06

(52) U.S. Cl. CPC B26D 1/03; B26D 3/06; B26D 7/06; B26D 5/26

(57) ABSTRACT

An apparatus and a method for cutting a cap are described, with a cutting device comprising a first blade for making a first circumferential cut, a second blade for making a second circumferential cut at an axial distance from the first circumferential cut, and one or more vertical and/or oblique blades for making one or more vertical and/or oblique cuts arranged between the first and the second circumferential cut, with a spindle comprising an engaging portion having one or more circumferential abutting surfaces arranged to contact a lateral wall of said cap, and a circumferential receiving hollow portion receiving at least partially and without contact the first blade, the second blade and the one or more vertical and/or oblique blades.

### BACKGROUND OF THE INVENTION

The invention relates to a cutting apparatus for cutting caps or plugs, for example made of plastics, of the kind used for closing containers such as bottles, for example. In particular, the invention relates to an apparatus for making circumferential cuts (at least for a part of the circumference or for the whole circumference) on a lateral wall of the caps.

Specifically, but not exclusively, the present invention can be used to make cuts to obtain so-called tethered caps. For these caps, several knives are usually arranged on a plurality of levels, with inclined or vertical traits, and, in addition, with horizontal traits usually featuring limited angular extents (namely, a less than 360 degrees cap turn).

The cuts made allow to achieve in the body of the cap either guarantee ring or band, or connecting portions (such as, for example, straps or hinges or joints, etc.) between a guarantee ring and a lateral wall of the cap, or to define other cap portions.

Cutting apparatuses are known that include a carousel structure that sets a plurality of cap engaging spindles into rotation, these being mounted on the carousel periphery, at an angular distance from one another, each of them being rotatable on itself. Each spindle sets the cap into self rotation and carries the cap along a circular advancement path, through one or more areas with cutting devices arranged therein, these providing for engraving or cutting of the lateral wall of the cap.

Cutting devices are known that are used to achieve either a weakening line on the lateral wall of the cap, so as to form a guarantee band, or horizontal openings on the cap. The kind of cut made by such devices is also known as “horizontal cut”.

Furthermore, cutting devices are known that are used to cut or engrave the lateral wall of a cap at certain radial positions, according to a direction which is parallel or inclined with respect to the axis of the cap, so as to achieve weakening areas within the guarantee band, or to define connecting portions (such as straps, hinges, etc.) between the guarantee band and the remaining part of the lateral wall of the cap. This kind of cut is also known as “vertical or oblique cut”.

Moreover, cutting devices are known that are adapted to make both a horizontal cut and a vertical or oblique cut on the lateral wall of the cap, with the cap at predefined radial positions.

Each spindle includes an engaging portion arranged to engage the cap by contacting an inner portion of the lateral wall of the cap, thus providing an abutment to the cutting arrangement when the spindle is in the cutting area.

In order to make a proper cut, the cutting device is to make a cut passing through predefined areas of the cap.

A prior art drawback is that said through cut is made by bringing the cutting device into contact with the engaging portion of the spindle. A repeated contact causes the wear of the cutting apparatus components involved, especially of the cutting device and of the engaging portion of the spindle.

Such a wear causes the cutting apparatus to lose functionality because the apparatus follows wrong notches (e.g., non-pass through notches), these thus implying a waste of notched caps which reduces the production yield of the cutting apparatus and increases the production costs of the caps.

Further, the wear of the components leads to frequent replacements of the components involved, and to unwanted machine downtimes contributing to lowering the production volumes of the caps notched by the cutting apparatus.

In the specific case of tethered caps, problems may be detected both with regard to the quality of the cut, as this is to be a perfect through cut, in the absence of any bridges, even after a prolonged use, and with regard to the useful life of the knives, especially because the horizontal traits, these usually featuring limited angular extents, are vertically more flexible, thus resulting in greater wear, chippings and other imperfections that reduce their effective useful life.

### SUMMARY OF THE INVENTION

An object of the invention is to improve the cutting apparatuses and methods of the known type for cutting caps.

An object is to provide an apparatus and/or method capable of overcoming one or more of the aforesaid prior art limitations and drawbacks.

An object is to provide an apparatus and/or method for cutting caps that are alternative with respect to prior art ones.

An advantage is to improve the quality of the cut and/or to extend the useful life of the knives especially used for cutting tethered caps, that is knives having one or more horizontal traits (usually with limited angular extents) arranged on a plurality of levels, in combination with oblique and vertical traits.

An advantage of the invention is to ensure proper execution of the cuts made on the caps.

An advantage is to implement an apparatus and/or method capable of removing any contact between the spindle and the cutting device.

An advantage is to provide a cutting tool for cutting caps that is simple in construction and cost-effective.

Other advantages are limiting the wear of the components of the apparatus for cutting caps, and reducing the production waste of notched caps.

These and other objects and advantages are attained by an apparatus and/or method according to one or more of the claims recited hereinbelow.

In one example, a cutting apparatus includes a cutting device and a spindle feeding a cap, the cap rolling on the cutting device, in which the cutting device includes at least two blades for making at least two circumferential cuts on the cap, and at least one blade for making at least an axial and/or inclined cut, arranged in an axial space defined between the two circumferential cuts, where “circumferential” and “axial” are meant with respect to an axis of the cap; and wherein the spindle includes at least two circumferential abutting surfaces arranged to contact the inside of the cap, and spaced from each other along an axial direction; at least two circumferential grooves arranged in an axial space defined between the two circumferential abutting surfaces, so as to receive, during the cutting, the cutting edges of the two blades making the circumferential cuts; and an intermediate surface comprised between the two circumferential grooves, such that during the cutting it is faced at a radial distance from a cutting edge of the blade making the axial and/or inclined cut.

In one example, a cutting apparatus includes a cutting device with a first blade for making a first circumferential cut on a cap, a second blade for making a second circumferential cut on the cap which is spaced from the first circumferential cut in an axial direction, and one or more blades for making one or more vertical and/or oblique cuts arranged between the first circumferential cut and the second circumferential cut in the axial direction, in which the cutting apparatus includes a spindle feeding the cap, the cap rolling on the cutting device, said spindle comprising an engaging portion provided with one or more circumferential abutting surfaces arranged for contacting internally the lateral wall of the cap, a receiving hollow portion which can receive, during the cutting, a cutting edge of the first blade keeping a first distance between a first external face of the receiving hollow portion and the cutting edge of the fist blade, a cutting edge of the second blade keeping a second distance between a second external face of the receiving hollow portion and the cutting edge of the second blade, and a cutting edge of the one or more vertical and/or oblique blades keeping a third distance between an intermediate external face of the receiving hollow portion and the cutting edge.

In one example, a cutting apparatus includes a cutting device with a first blade for making a first circumferential cut on a cap, a second blade for making a second circumferential cut on the cap, spaced from the first circumferential cut along an axial direction, and one or more vertical and/or oblique blades for making one or more vertical and/or oblique cuts arranged between the first circumferential cut and the second circumferential cut along the axial direction, in which the cutting apparatus includes a spindle feeding the cap, the cap rolling on the cutting device, said spindle comprising an engaging portion provided with one or more circumferential abutting surfaces arranged so as to contact the inside of said cap; a first circumferential groove adapted to receive, during the cutting, a cutting edge of the first blade, while keeping a first distance between a bottom of the first groove and the cutting edge of the first blade; and a second circumferential groove adapted to receive, during the cutting, a cutting edge of the second blade, while keeping a second distance between a bottom of the second groove and the cutting edge of the second blade.

### BRIEF DESCRIPTION OF THE DRAWINGS

The invention can be better understood and implemented with reference to the attached drawings that show exemplary, non-limiting embodiments thereof, in which:

FIG. 1 is an axial section of an apparatus for cutting caps, showing a spindle according a first embodiment, a support and a cutting device in a cap cutting configuration, the section being taken in a plane intersecting a rotation axis of the spindle;

FIG. 2 is an enlargement of FIG. 1 showing an engaging portion of the spindle with at least two grooves and at least one intermediate portion, and the cutting device with at least two horizontal blades and a cutting arrangement;

FIG. 3 is an enlargement of FIG. 1 illustrating some dimensions of the engaging portion;

FIG. 4 is an enlargement of FIG. 1 illustrating a first distance between a first horizontal blade and the bottom of a first groove, a second distance between a second horizontal blade and a bottom of a second groove, and a third distance between a blade of the cutting arrangement and the at least one intermediate portion;

FIG. 5 is an enlargement of FIG. 1 illustrating an exceeding distance of the horizontal blades as well as an exceeding distance of the cutting arrangement;

FIG. 6 is a section of a cutting apparatus according to a further embodiment, wherein each of the first horizontal blade and the second horizontal blade is only sharpened on one side;

FIG. 7 is a schematic plan view of a cutting apparatus portion highlighting an advancement direction of an advancement path of the cap in the cutting apparatus, and the cutting device;

FIG. 8a is a section of a cutting apparatus according to a further embodiment, wherein the second groove is smaller in size than the first groove;

FIG. 8b is a section of a cutting apparatus according to a further embodiment, wherein the first groove is smaller in size than the second groove.

FIG. 9 is an axial section of a cutting apparatus showing a spindle according to a second embodiment in which a single groove is provided, a support and a cutting device in a cap cutting configuration, the section being taken in a plane intersecting a rotation axis of the spindle;

FIG. 10 is an enlargement of FIG. 9 illustrating some dimensions of the engaging portion of the spindle according to the second embodiment;

FIG. 11 is an enlargement of FIG. 9 illustrating a further first distance between the first horizontal blade and a bottom of the single groove, a further second distance between the second horizontal blade and the bottom of the single groove, and a further third distance between a blade of the cutting arrangement and the bottom of the single groove.

### DETAILED DESCRIPTION

Referring to the aforementioned Figures, a cutting apparatus arranged to cut or engrave plugs or caps 1 is described. In particular, the caps 1 can be used for closing containers such as bottles, for example.

The cap 1 may include, in particular, a cup-shaped body with a base wall defining a closed end of the cup-shaped body. The base wall includes an inner face and an outer face opposed to each other. The base wall may be, in particular, in the form of a disc, and may include a central region intersected by a longitudinal axis C, this being, in particular, orthogonal relative to the base wall, as well as a peripheral region close to a peripheral edge of the disc, and more distant from the longitudinal axis C than the central region. The cap 1 may include, in particular, a lateral wall 12 contiguous with the base wall extending around the longitudinal axis C of the cap 1 up to a free edge of the base wall 12, such free edge defining an open end of the cup-shaped body. The lateral wall 12 may be, in particular, a cylinder-shaped lateral wall coaxial with the longitudinal axis C.

The cap 1 may include, in particular, at least one circumferential cut meant to separate the cap 1 into a main body comprising the closed end of the cap 1, and a guarantee band comprising an open ring-shaped cap portion. The circumferential cut may include, in particular, a plurality of easy fracturing lines, or weakening lines, that may be arranged on the cap 1 according to several inclinations relative to the longitudinal axis C, so as to define, on the cap, the main body, the guarantee band and any connecting portion linking the main body to the guarantee band, namely a strap.

The cutting apparatus may include, in particular, an advancement path travelable by the cap 1 along an advancement direction T. Such advancement path may include, in particular, a circumferential arc, and may be defined within a peripheral area of a spindle-holding carousel (not shown, included in the cutting apparatus) which rotates around a vertical axis of revolution, in particular orthogonal relative to a horizontal basement of the apparatus, and which sets a plurality of spindles 2 and a plurality of supports 3, arranged to move the caps 1, in rotation about the vertical axis of revolution.

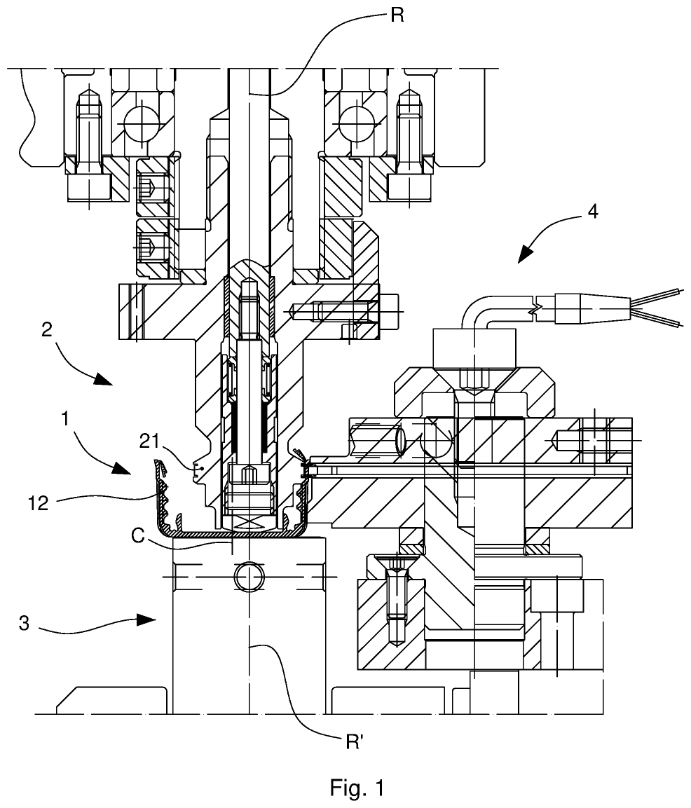

Referring to FIG. 1, the spindle 2 is shaped to interact with the cap 1 to feed the cap 1 along the advancement path. The rotation axes R of the several spindles may be, in particular, vertical, or in any case parallel to the carousel's axis of revolution.

In an embodiment not shown, the longitudinal axis C of the cap may be, in particular, coaxial with the spindle's rotation axis R.

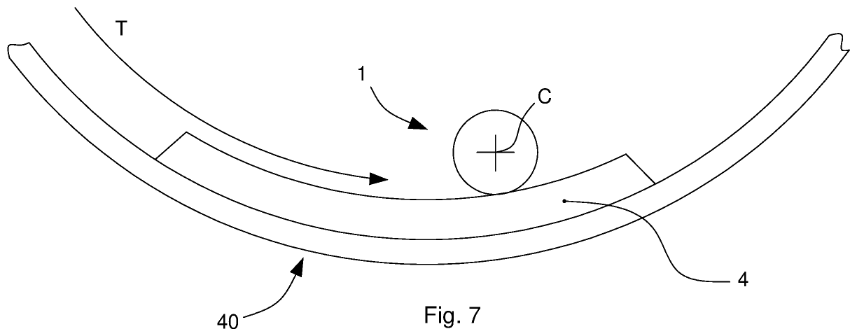

Referring to FIG. 7, the cutting apparatus may include a cutting zone 40 reached and crossed by the spindle 2 and by the support 3 during the functioning of the cutting apparatus. The cutting apparatus further includes an entry or feeding zone, upstream of the cutting zone 40, and a discharge zone, downstream of the cutting zone 40.

The cutting apparatus may include, in particular, a cutting device 4, arranged within the cutting zone 40 to cut the cap 1.

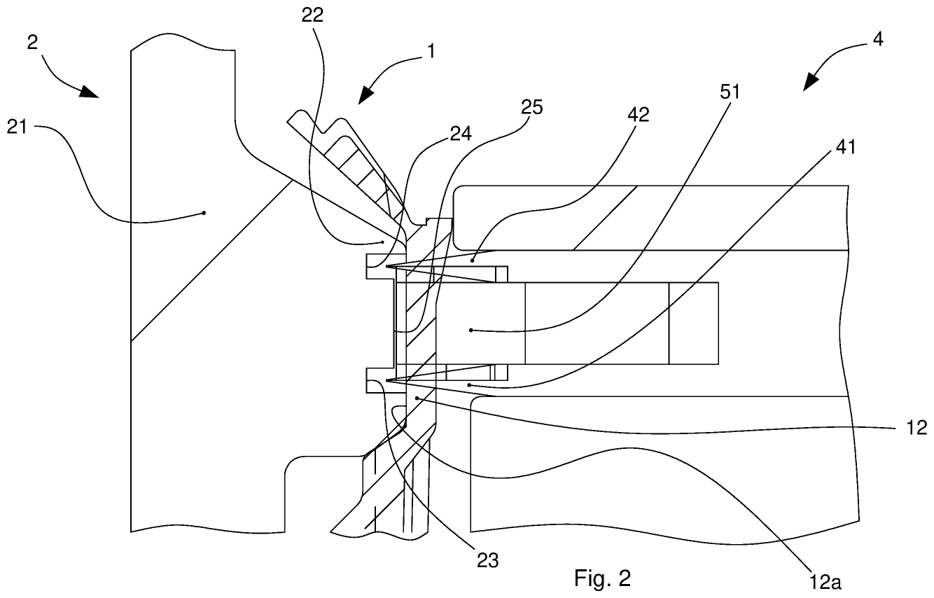

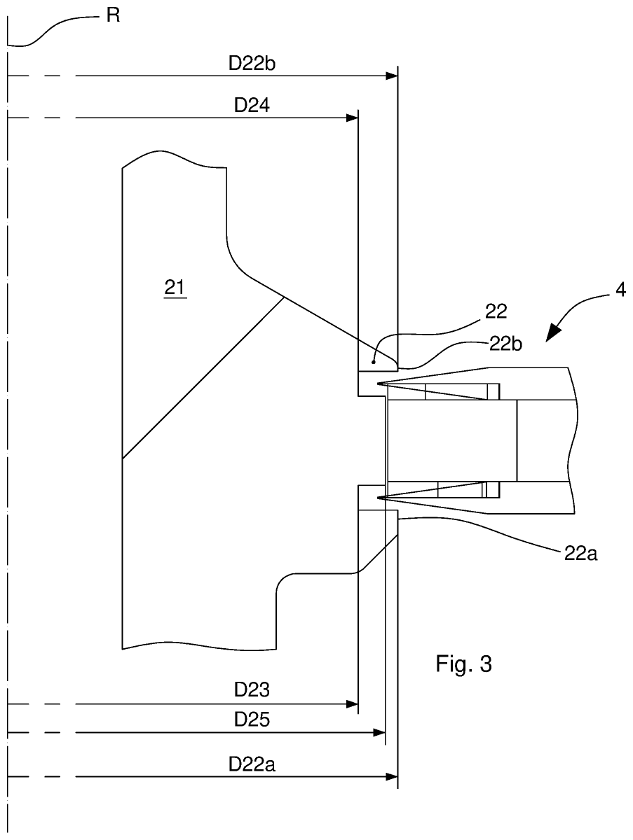

Referring to FIGS. 2 and 3, the cutting device 4 may include, in particular, at least one first blade 41 which is horizontal and configured to make one or more circumferential cuts on the cap 1. Here, “horizontal” shall be understood to mean that the blade is arranged substantially parallel to the cap advancement direction (this usually being horizontal) when it passes through the cutting zone.

The first blade 41 may be obtained on a plate body comprising an upper side and a lower side opposite to the upper side. The first blade 41 is provided with at least one horizontal cutting edge which in use faces the cap 1 and is arranged to penetrate the cap 1. The first blade 41 may be configured, in particular, to make a cut along a first (usually horizontal) plane substantially orthogonal relative to the longitudinal axis C of the lateral wall 12 of the cap 1, at one first vertical height.

The cutting device 4 may include, in particular, at least one second blade 42 (which is also horizontal, as understood above) which in particular may be configured to make one or more circumferential cuts on the cap. The second blade 42 may be configured, in particular, to make a cut along a second (horizontal) plane orthogonal relative to the longitudinal axis C of the lateral wall 12 of the cap 1, at a second vertical height (different from the first height). The second blade 42 may be obtained on a plate body comprising an additional upper side and an additional lower side opposite to the additional upper side. The second blade 42 may be provided with at least one horizontal cutting edge which in use faces the cap 1 and is arranged to penetrate the cap 1.

The first blade 41 and the second blade 42 may be vertically spaced from each other. In particular, the first blade 41 may be positioned at a vertical height less than a height of the second blade 42.

The cutting device 4 may include, in particular, a cutting arrangement 51 that may include at least one cutting insert, or at least one cutting element, or at least one cutting assembly, or at least one cutting group.

The cutting arrangement 51 may include, in particular, one or more vertical and/or oblique blades configured to make one or more vertical and/or oblique cuts on the cap 1. The cutting arrangement 51 may be provided with at least one vertical or inclined cutting edge which in use faces the cap 1 and is arranged to penetrate the cap 1. The cutting arrangement 51 may be configured, in particular, to make one or more vertical incisions and/or one or more oblique incisions on the lateral wall 12 of the cap 1.

The cutting arrangement 51 may be arranged in a zone vertically comprised between the first blade 41 and the second blade 42. In the specific example shown in the figures, the cutting device includes a sandwich or stack structure, in which the cutting arrangement 51 is interposed between the first blade 41 and the second blade 42. In an additional embodiment, not shown, the cutting device may be monobloc.

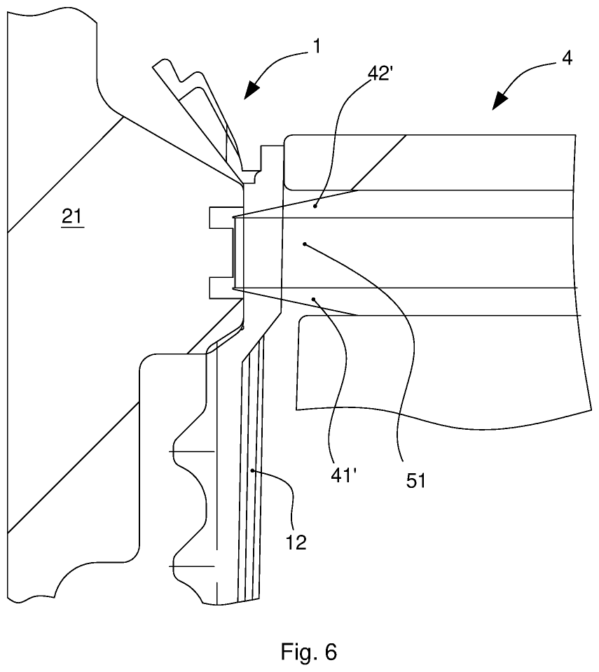

Referring to the specific example in FIGS. 1, 2, 3, 4, 5, the blades of the cutting device 4, in particular the first blade 41 and the second blade 42, may be sharpened on both sides. Alternatively, in an additional embodiment, the blades may be provided with a single edge sharpening, i.e. each of them may be sharpened only on one side. Referring to FIG. 6, a first horizontal blade sharpened on its lower side is indicated by 41′, and a second horizontal blade sharpened on its upper side is indicated by 42′. In particular, the single edge sharpening may occur on the blade side opposite to the cutting arrangement 51, and may be envisaged when the distance between the horizontal cuts is reduced, that is, when the distance between the first blade 41 and the second blade 42 is reduced. This solution envisaging the single edge sharpening of the blades, especially of the horizontal blades, may be applied to any of the embodiments as described above.

The cutting device 4 includes, in particular, a guide (not shown) arranged to contact an outer portion of the cap 1, and to set the cap 1 into rotation as the spindle 2 advances along the advancement path. The guide may include, in particular, a knurled section which in use faces the spindle 2. Such knurled section is configured to appropriately engage the outer portion of the cap 1, and to set the cap 1 into rotation about the longitudinal axis C.

Alternatively or additionally, the guide may include, in particular, blade portions of the cutting device 4 arranged both to allow the rolling of the cap 1, and, at the same time, to make cuts on the cap 1. In other words, the cap 1 can roll on the blades of the cutting device 4 while cuts are being made on the cap itself.

The cutting apparatus may include, in particular, a spindle 2 which is movable along the advancement path and rotatable around its rotation axis R. Such rotation axis R may be vertical and/or parallel to the carousel's axis of revolution and/or perpendicular to a plane in which the cap path develops.

The spindle 2 may include, in particular, an engaging portion 21 which is rotatable around the rotation axis R and configured to engage an inner portion of the cap 1, such that the cap longitudinal axis C is parallel to the rotation axis R of the spindle. The engaging portion 21 can rotate, in particular, to reduce any unwanted slip between the cap 1 and the spindle 2 when the cap 1 rolls on the cutting device 4. Additionally or alternatively, the engaging portion 21 can set the cap 1 into active rotation by contacting the inner portion of the cap 1. The rolling of the cap 1 is useful, in particular, for making the (circumferential) horizontal cuts and the vertical and/or oblique cuts on the cap 1 itself when the spindle 2 reaches the cutting zone 40. In particular, in an embodiment, not shown, the cap longitudinal axis C may be coaxial with the rotation axis R of the spindle.

The engaging portion 21 may include, in particular, a cylinder- or ring-shaped external surface extending around the rotation axis R.

The engaging portion 21 may include, in particular, at least one circumferential or annular abutting surface, arranged to contact an inner portion of the cap 1. In particular the engaging portion 21 is arranged to contact one or more inner portions of the lateral wall 12 of the cap 1.

Referring especially to FIG. 3, the engaging portion 21 may include, in particular, a first abutting surface 22a and a second abutting surface 22b vertically spaced from each other.

The engaging portion 21 may include, in particular, a receiving hollow portion 23, 24, 25, 26 which is circumferential for receiving at least partially the fist blade 41, the second blade 42 and the cutting arrangement 51.

The receiving hollow portion 23, 24, 25, 26 may be configured, in particular, so that, when the cap 1 rolls on the cutting device 4: the first blade 41 is received keeping a first distance S23, S23′ between a first external face of the receiving hollow portion 23, 24, 25, 26 and a cutting edge of the first blade 41 so as to avoid a contact between the first externa face and the cutting edge; the second blade 42 is received keeping a second distance S24, S24′ between a second external face of the receiving hollow portion 23, 24, 25, 26 and a cutting edge of the second blade 42 so as to avoid a contact between the second external face and the cutting edge; the cutting arrangement 51 is received keeping a third distance S25, S25′ between a intermediate external face of the receiving hollow portion 23, 24, 25, 26 and the cutting arrangement 51 so as to avoid a contact between the intermediate external face and the cutting arrangement.

The intermediate external face can be interposed, in particular, between the first external face and the second external face.

In the cutting apparatus, when the cap 1 rolls on the cutting device 4, the cutting edge of the first blade 41 is closer to the rotation axis R than the first abutting surface 22a so that the first blade 41 completely penetrates a thickness of the cap 1 without contacting the first external face of the receiving hollow portion 23, 24, 25, 26. In addition or alternatively, in the cutting apparatus, when the cap 1 rolls on the cutting device 4, the cutting edge of the second blade 42 is closer to the rotation axis R than the second abutting surface 22b so that the second blade 42 completely penetrates a thickness of the cap 1 without contacting the second external face of the receiving hollow portion 23, 24, 25, 26.

In addition or alternatively, in the cutting apparatus, when the cap 1 rolls on the cutting device 4, the cutting edge of the cutting arrangement 51 is closer to the rotation axis R than the first abutting surface 22a and/or the second abutting surface 22b so that the cutting edge of the cutting arrangement 51 completely penetrates a thickness of the cap 1 without contacting the intermediate external face of the receiving hollow portion 23, 24, 25, 26.

In the spindle 2 according to a first embodiment the receiving hollow portion 23, 24, 25, 26 includes more circumferential grooves and an intermediate portion which will be described later.

Referring now to FIGS. 2 and 3, in the spindle according to the first embodiment which is indicated with the reference number 2, the engaging portion 21 may include, in particular, at least one first groove 23 which is circumferential, or annular, obtained on the external surface of the engaging portion 21. The first groove 23 is provided with a bottom facing outwards of the engaging portion 21, according to a radial direction with respect to the rotation axis R.

The first groove 23 may be configured such that when the cap 1 rolls on the cutting device 4, the first blade 41 is received at least partially within the first groove 23 keeping a first distance S23 between the bottom of the first groove 23 and the cutting edge of the first blade 41 so as to avoid any contact between the bottom and the cutting edge.

In the spindle 2 according to the first embodiment, the engaging portion 21 may include, in particular, at least one second groove 24 which is circumferential, or annular, obtained on the external surface of the engaging portion 21. The second groove 24 may be, in particular, vertically spaced from the first groove 23. In particular, the second groove 24 may be provided with a bottom facing outwards of the engaging portion 21 according to a radial direction with respect to the rotation axis R.

The second groove 24 may be configured such that, when the cap 1 rolls on the cutting device 4, the second blade 42 is received at least partially within the second groove 24, keeping a second distance S24 between the bottom of the second groove 24 and the cutting edge of the second blade 42, so as to avoid any contact between the bottom of the second groove 24 and the cutting edge of the second blade 42.

In the spindle 2 according to the first embodiment, the engaging portion 21 may include, in particular, at least one intermediate portion 25 which is circumferential or annular, and is vertically arranged between the first groove 23 and the second groove 24.
the engaging portion 21 may include, in particular, a circumferential external surface which in use faces an inner face of the lateral wall 12 of the cap 1. The intermediate portion 25 may be configured such that, when the cap 1 rolls on the cutting device 4, a third distance S25 is kept between the external surface of the intermediate portion 25 and the cutting edge(s) of the cutting arrangement 51, so as to avoid any contact between the external surface of the intermediate portion 25 and the cutting edge(s) of the cutting arrangement 51. The third distance S25 may be comprised, in particular, within a range from 0.02 mm to 0.20 mm, in particular from 0.05 mm to 0.15 mm. In particular the distance S25 may be 0.05 mm.

The receiving hollow portion 23, 24, 25, 26 can be interposed vertically between the first abutting surface 22a and the second abutting surface 22b.

In the specific example shown in FIGS. 1-6, the first groove 23 and the second groove 24 are arranged between the first abutting surface 22a and the second abutting surface 22b.

Referring to FIG. 2, when the cap 1 rolls on the cutting device 4, the cutting edge of the first blade 41 is closer to the rotation axis R than the first abutting surface 22a, such that the first blade 41 completely penetrates a thickness of the cap 1 without contacting the bottom of the first groove 23.

Moreover, in this situation, the cutting edge of the second blade 42 is closer to the rotation axis R than the second abutting surface 22b, such that the second blade 42 completely penetrates a thickness of the cap 1 without contacting the bottom of the second groove 24.

Furthermore, in this situation, at least one cutting edge of the cutting arrangement 51 completely penetrates a thickness of the cap 1 without contacting the external surface of the intermediate portion 25.

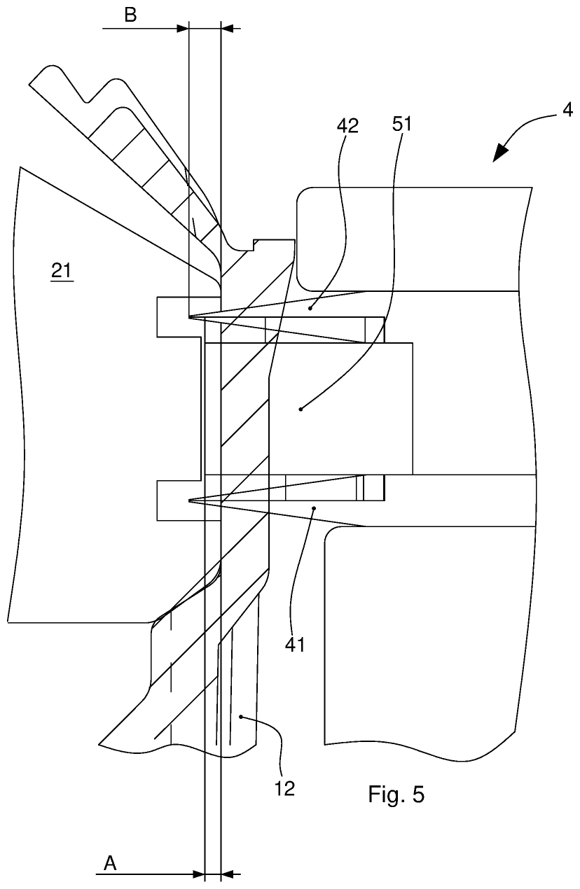

Moreover, in this situation, referring especially to FIG. 5, the cutting edge(s) of the cutting arrangement 51 is (are) arranged to protrude from the lateral wall 12 of the cap 1 towards the rotation axis R by an exceeding distance A selected on the basis of the thickness of the lateral wall 12. By “exceeding” is meant the protruding of one or more cutting edges from an internal surface of the lateral wall 12 towards the rotation axis R. The distance A may range from 10% to 40%, preferably from 20% to 30%, of the thickness of the lateral wall 12. In particular the distance A amounts to 25% of the thickness of the lateral wall 12. The thickness of the lateral wall 12 may be in the range from 0.5 mm to 2.0 mm, in particular from 0.6 mm to 1.2 mm. In particular the thickness of the lateral wall 12 may be from 0.6 mm to 1.0 mm. Moreover, in this situation, the cutting edge(s) of the first blade 41 and/or of the second blade 42 are arranged to protrude from the lateral wall 12 towards the rotation axis R by an exceeding distance B selected on the basis of the distance A. The distance B may range from 120% to 250%, in particular from 150% to 200% of the distance A.

The receiving hollow portion 23, 24, 25, 26 may have, in particular, a diameter that may be less than a diameter D22a, D22b of the at least one abutting surface 22a, 22b. Such diameters being measured on an plan orthogonal to the rotation axis R.

Referring to FIGS. 2 and 3, the bottom of the first groove 23 may have, in particular, a diameter D23 that is less than a diameter D22a of the first abutting surface 22a, so as not to contact the lateral wall 12 of the cap 1.

Moreover, the bottom of the second groove 24 has a diameter D24 that may be, in particular, less than a diameter D22b of the second abutting surface 22b, so as not to contact the lateral wall 12 of the cap 1.

The external surface of the intermediate portion 25 may have, in particular, a diameter D25 that is lower than the diameter D22a of the first abutting surface 22a and/or of the diameter D22b of the second abutting surface 22b, such that the external surface of the intermediate portion 25 does not contact the lateral wall 12 of the cap 1.

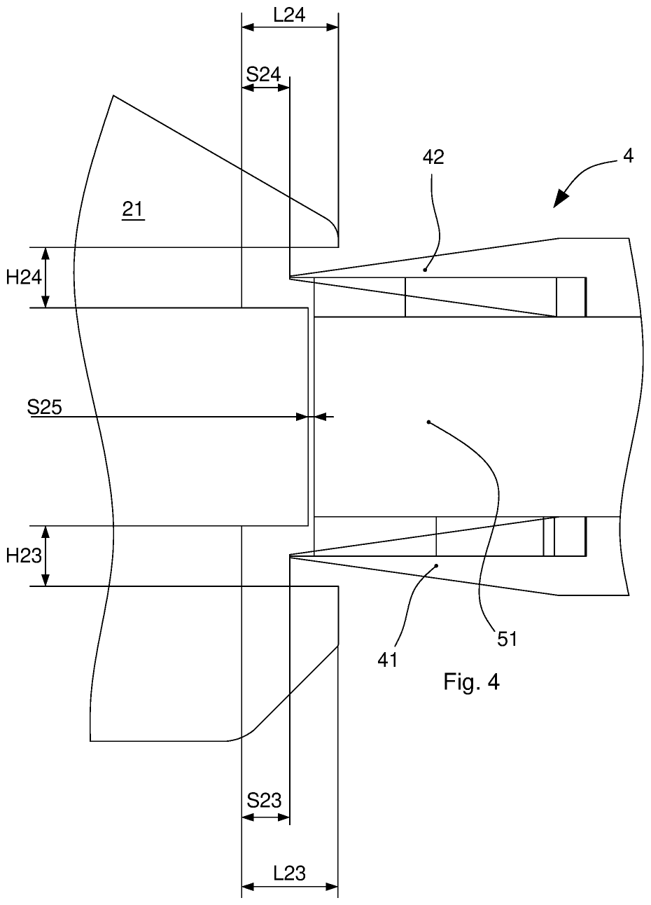

Referring to FIGS. 3 and 4, the cutting apparatus may be realized such that when the cap 1 rolls on the cutting device 4, at least one of the situations defined by the following formula

(D22−D25)÷2>N×S25

is satisfied, where D22=D22a and/or D22=D22b, and where N=2, or N=3, or N=4, or N=5, or N=6, or N>2, or N>3, or N>4, or 3<N<7, or 4<N<6.

It has been found that such situations prevent the cutting arrangement 51 from excessively deforming the lateral wall 12 of the cap 1.

In other words, in the aforementioned situations, a difference between the radius D22a/2 of the first abutting surface 22a, and/or the radius D22b/2 of the second abutting surface 22b, and the radius D25/2 of the intermediate portion 25 turns out to be greater than the third distance S25 multiplied by N, where N>2, in particular greater than twice, than thrice, than four times or than five times, or greater than non-integer values of N falling within the aforementioned ranges. It is observed that in the specific example shown in the Figures, the diameters D22a and D22b are equal to each other.

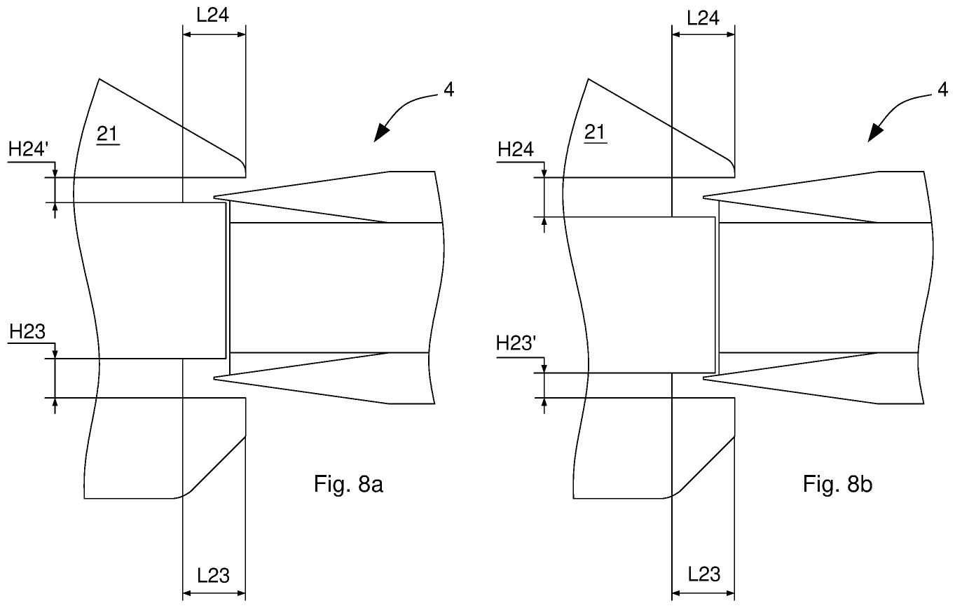

Referring to the variant embodiment in FIG. 4, the cross-sectional dimensions of the first groove 23 may be L23×H23=0.8 mm×0.5 mm, in which a distance L23 between the first abutting surface 22a and the bottom of the first groove 23 is equal to 0.8 mm, and the bottom of the first groove 23 extends vertically by a height H23 of 0.5 mm. The cross-sectional dimensions of the second groove 24 may be L24×H24=0.8 mm×0.5 mm, in which a distance L24 between the second abutting surface 22b and the bottom of the second groove 24 is equal to 0.8 mm, and the bottom of the second groove 24 extends vertically by a height H24 of 0.5 mm. Alternatively, the grooves may be arranged asymmetrically with respect to the intermediate portion 25 of the spindle 2. In other words, the grooves 23, 24 may have cross-sectional dimensions which are different for each groove 23, 24. In particular, in the second groove 24 at least one dimension, in particular the height H24′, may be lower than the corresponding dimension in the first groove 23. Referring to a further embodiment shown in FIG. 8a, the cross-sectional dimensions of the second groove 24 may be L24×H24′=0.8 mm×0.3 mm, that is, the vertical height H24′ of the bottom of the second groove 24 may be lower than the height H23 of the bottom of the first groove 23. Alternatively, in the first groove 23, at least one dimension, in particular the height H23′, may be lower than the corresponding dimension of the second groove 24. Referring to a further embodiment shown in FIG. 8b, the cross-sectional dimensions of the first groove 23 may be L23×H23′=0.8 mm×0.3 mm, that is, the vertical height H23′ of the bottom of the first groove 23 may be lower than the height H24 of the bottom of the second groove 24. This solution of providing an asymmetrical arrangement of the grooves 23, 24 may be applied to any of the embodiments described.

In a further variant embodiment, not shown, it may be provided that, when the cap 1 rolls on the cutting device 4, at least one single groove, in particular the first groove or the second groove or an additional circumferential groove, is arranged at one or more additional horizontal blades, so as to also receive, at least partially, one or more additional horizontal blades, in addition to the blade described above.

In the engaging portion 21 of the spindle 2 according to the first embodiment, the intermediate portion 25 projects radially from the bottom of the first groove 23 and the bottom of the second groove 24, where “radially” is intended with respect to the rotation axis R.

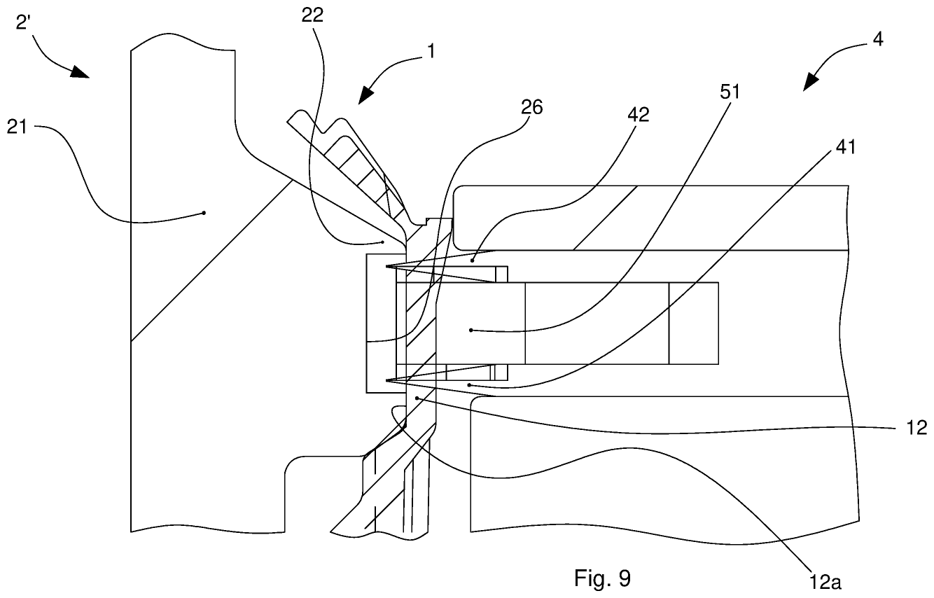

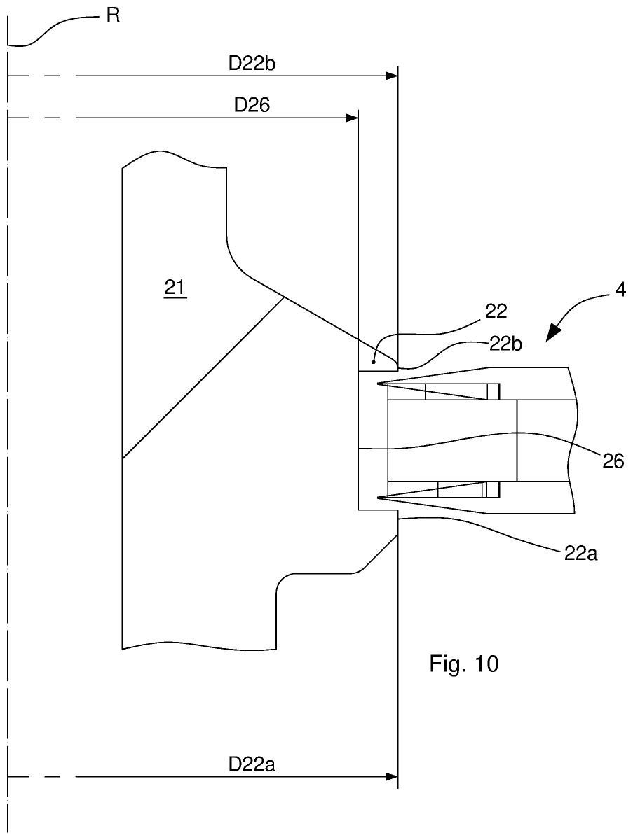

In a second embodiment of the spindle which is indicated with the reference number 2′ (and which is illustrated in FIGS. 9, 10, and 11) the receiving hollow portion 23, 24, 25, 26 includes a single groove 26.

The single groove 26 provided on the spindle 2′ is configured, in particular, to receive at least partially the first blade 41, the second blade 42 and the cutting arrangement 51.

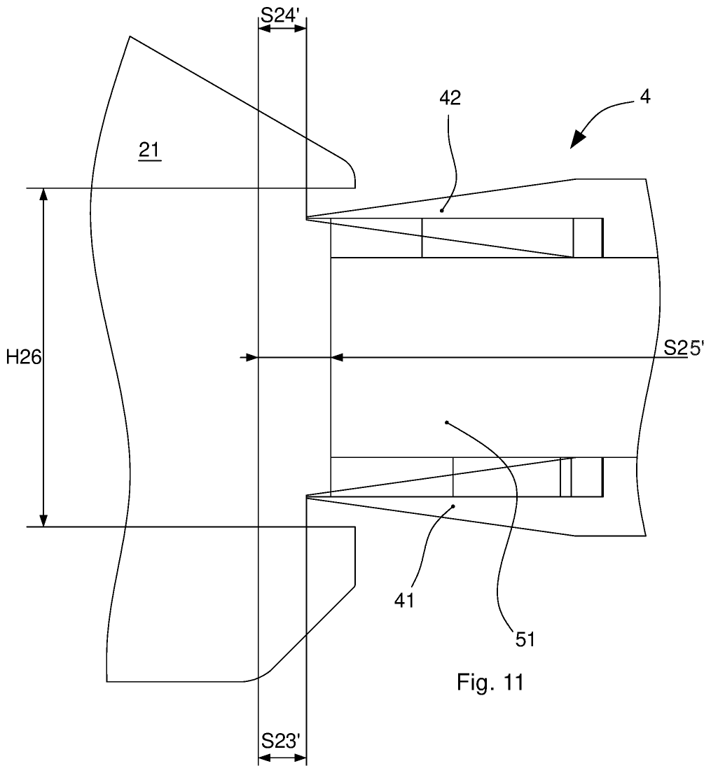

In the specific embodiment of FIG. 11, the single groove 26 is cylindrical in shape and extends vertically by a height H26 between the first abutting surface 22a and the second abutting surface 22b. Referring now to FIG. 11, the bottom of the single groove 26 may have, in particular, a diameter D26 which is less than the diameter D22a of the first abutting surface 22a and/or the diameter D22b of the second abutting surface 22b, so that the bottom of the single groove 26 does not contact the lateral wall 12 of the cap 1 when the cap 1 rolls on the cutting device 4. The single groove 26 is arranged, in particular, for housing at least partially the cutting edges of the cutting device 4 when the cap 1 rolls on the cutting device 4. The configuration provided by the spindle 2′ according to the second embodiment allows an advancement of the cutting edges of the cutting device 4, in particular an advancement of the cutting edges of the cutting arrangement 51, towards the rotation axis R.

The spindle 2′ according to the second embodiment is movable along the advancement path to feed the cap 1 to the cutting zone 40 and is rotatable around its rotation axis R. The spindle 2′ according to the second embodiment includes an engaging portion 21 rotatable around the rotation axis R and configured to engage an inner portion of the cap 1, the cap 1 rolling on the cutting device 4 for making cuts when the spindle 2′ reaches the cutting zone 40. The engaging portion 21 of the spindle 2′ according to the second embodiment includes, in particular, the at least one abutting surface 22a, 22b which is circumferential and arranged for contacting an internal portion of the lateral wall 12 of the cap 1. The engaging portion 21 of the spindle 2′ according to the second embodiment includes, in particular, a single groove 26 which is circumferential and configured so that, when the cap 1 rolls on the cutting device 4, the first blade 41 is received at least partially into the single groove 26 keeping a further first distance S23′ between the bottom of the single groove 26 and a cutting edge of the first blade 41 so as to avoid a contact between the bottom of the single groove 26 and the cutting edge of the first blade 41. Further, the single groove 26 is configured so that, when the cap 1 rolls on the cutting device 4, the second blade is received at least partially into the single groove 26 keeping a further second distance S24′ between the bottom of the single groove 26 and a cutting edge of the second blade 42 so as to avoid a contact between the bottom of the single groove 26 and the cutting edge of the second blade 42. Further, the single groove 26 is configured so that, when the cap 1 rolls on the cutting device 4, the cutting arrangement 51 is facing said single groove 26 keeping a further third distance S25′ between the bottom of said single groove 26 and the cutting arrangement 51 so as to avoid a contact between the bottom of the single groove 26 and the cutting arrangement 51.

In other words, the spindle 2′ according to the second embodiment is comparable to the spindle 2 according to the first embodiment in which the diameter D25 of the external surface of the intermediate portion 25 is equal to both the diameter D23 of the bottom of the first groove 23 and the diameter D24 of the bottom of the second groove 24 thus making the single groove 26. Similarly, the first distance S23 between the bottom of the first groove 23 and the cutting edge of the first blade 41, the second distance S24 between the bottom of the second groove 24 and the cutting edge of the second blade 42, the third distance S25 between the external surface of the intermediate portion 25 and the cutting arrangement 51 are comparable to the further first distance S23′, the further second distance S24′ and the further third distance S25′ respectively.

In the spindle 2′ according to the second embodiment, the further first distance S23′, the further second distance S24′ and the further third distance S25′ can be equal. In this situation, the cutting edge of the first blade 41, the cutting edge of the second blade 42 and the cutting edge of the cutting arrangement 51 are aligned vertically and are spaced the same distance from the single groove 26.

The cutting apparatus may include, in particular, an adjustment device configured to vary a position of the cutting device 4 as a whole, and/or configured to vary a position of one or more parts of the cutting device 4 independently of one another. In this manner, it is possible to adjust the cutting device 4 by moving the blades close to the advancement path of the cap, especially when these blades are worn out, in particular when they are so worn out that they no longer allow a complete penetration of the thickness of the cap 1.

Such an adjustment may be carried out in an independent manner for each blade, as these blades may be subject to differentiated wear behaviors, since, for example, they cut the cap according to different thicknesses. The adjustment device may include, in particular, a first adjustment device, a second adjustment device and a third adjustment device arrangement, as will be described below.

The cutting apparatus may include, in particular, a first adjustment device configured to vary a position of the cutting device 4 along a direction which is transverse, in particular in a horizontal plane, with respect to the advancement path, by moving the cutting device 4 close and/or away to/from the advancement path, such that when the cap 1 rolls on the cutting device 4, the first distance S23, the second distance S24 and the third distance S25 are varied by the same amount, so as to compensate the wear of the cutting edges of the cutting device 4.

The cutting apparatus may include, in particular, a second adjustment device configured to vary a position of the first blade 41 and of the second blade 42 independently of the position of the cutting arrangement 51 along a direction which is transverse with respect to the advancement path, by moving the assembly consisting of the first blade 41 and the second blade 42 close and/or away to/from the advancement path, such that when the cap 1 rolls on the cutting device 4, the first distance S23 and the second distance S24 have been adjusted by an additional same amount, so as to compensate the wear of the cutting edges of the first blade 41 and the second blade 42.

Moreover, the second adjustment device may be configured to vary a mutual position between the first blade 41 and the second blade 42 in an independent manner along a direction which is transverse with respect to the advancement path, such that when the cap 1 rolls on the cutting device 4, the first distance S23 has been adjusted independently of the second distance S24, and vice versa, so as to be able to compensate a differentiated wear behavior between the first blade 41 and the second horizontal blade 42.

The cutting apparatus may include, in particular, a third adjustment device configured to vary a position of the cutting arrangement 51 in an independent manner relative to the first blade 41 and the second blade 42 along a direction which is transverse with respect to the advancement path, by moving the cutting arrangement 51 close and/or away to/from the advancement path, such that when the cap 1 rolls on the cutting device 4, the third distance S25 has been adjusted to compensate the wear of the cutting arrangement 51.

The adjustment device may include, in particular, one or more micrometric screws, configured such that a rotation of a micrometric screw is associated with a displacement, especially a linear displacement, of one or more blades of the cutting device 4. The first adjustment device may include, in particular, one or more micrometric screws. The second adjustment device may include, in particular, one or more micrometric screws. The third adjustment device may include, in particular, one or more micrometric screws.

The function of the cutting apparatus implements, in particular, a cutting method for cutting a cap, which may include, in particular, the step of feeding a cap 1 along the advancement path up to the cutting zone 40 where the cutting device 4 is arranged.

The cutting method may include, in particular, the step of engaging the cap 1 with the engaging portion 21 of the spindle 2.

The cutting method may include, in particular, the step of allowing the cap 1 to roll on the cutting device 4.

The cutting method may include, in particular, the step of making one or more circumferential cuts on the cap 1 by means of the first blade 41, one or more circumferential cuts on the cap 1 by means of the second blade 42, and one or more vertical and/or oblique cuts on the cap 1 by means of the cutting arrangement arranged between the first blade 41 and the second blade 42, during the rolling of the cap.

As the cap rolls, the first blade 41 is received at least partially within the cavity defined by the first circumferential groove 23 obtained on the engaging portion 21, keeping the first distance S23 between the bottom of the first groove 23 and the cutting edge of the first blade 41, so as to avoid any contact (and the resulting wear effect) between the bottom and the cutting edge.

Furthermore, as the cap rolls, the second blade 42 is received at least partially within the cavity defined by the second circumferential groove 24 obtained on the engaging portion 21, keeping a second distance S24 between the bottom of the second groove 24 and a cutting edge of the second blade 42, so as to avoid any contact (and the resulting wear effect) between the bottom and the cutting edge of the second blade 42.

As the cap rolls, the cutting arrangement 51 faces the intermediate circumferential portion 25 of the engaging portion 21 arranged between the first groove 23 and the second groove 24, keeping a third distance S25 between the external surface of the intermediate portion 25 and the cutting arrangement 51, so as to avoid any contact (and the resulting wear effect) between the external surface and the cutting arrangement.

It is observed that the use of means for independently adjusting the position of the several knives or blades allows to adjust the penetration of the single knives or blades in an independent manner, so as to effectively compensate the wear behavior of the single knives or blades, especially in this kind of apparatuses, suitable for making caps of the tethered kind, in which the several blades cut the cap in areas having different angular extents, with different cap thicknesses, such that a differentiated adjustment for every blade turns out to be particularly advantageous.

1. Cutting apparatus for cutting a cap, comprising:
an advancement path travelable by said cap;
a cutting zone arranged on said advancement path;
a cutting device arranged in said cutting zone for cutting said cap, said cutting device comprising:
at least one first blade which is horizontal and which is configured to make one or more circumferential cuts on said cap;
at least one second blade which is horizontal and which is configured to make one or more circumferential cuts on said cap, said at least one first blade (41) and said at least one second blade being vertically spaced from each other;
a cutting arrangement with one or more vertical and/or oblique blades configured to make one or more vertical and/or oblique cuts on said cap (1), said cutting arrangement being arranged in a zone vertically comprised between said at least one first blade and said at least one second blade;
a spindle which is movable along said advancement path to feed said cap to said cutting zone and which is rotatable around a rotation axis, said spindle comprising an engaging portion which is rotatable around said rotation axis and which is configured to engage an inner portion of said cap, said cap rolling on said cutting device to make said cuts when said spindle (reaches said cutting zone, said engaging portion comprising:
at least one abutting surface which is circumferential and which is arranged for contacting an inner portion of a lateral wall of said cap;
a receiving hollow portion which is circumferential for receiving at least partially said at least one first blade, said at least one second blade and said cutting arrangement, said receiving hollow portion being configured so that, when said cap rolls on said cutting device:
said first blade is received keeping a first distance between a first external face of said receiving hollow portion and a cutting edge of said first blade so as to avoid a contact between said first external face and said cutting edge;
said second blade is received keeping a second distance between a second external face of said receiving hollow portion and a cutting edge of said second blade so as to avoid a contact between said second external face and said cutting edge;
said cutting arrangement is received keeping a third distance between an intermediate external face of said receiving hollow portion and said cutting arrangement so as to avoid a contact between said intermediate external face and said cutting arrangement, said intermediate external face being interposed between said first external face and said second external face.

2. Cutting apparatus according to claim 1, wherein said at least one abutting surface includes a first abutting surface and a second abutting surface, said receiving hollow portion being vertically arranged between said first abutting surface and said second abutting surface.

3. Cutting apparatus according to claim 2, wherein, when said cap rolls on said cutting device, said cutting edge of said at least one blade is closer to said rotation axis than said first abutting surface so that said first blade completely penetrates a thickness of said cap without contacting said first external face of said receiving hollow portion.

4. Cutting apparatus according to claim 2 or 3, wherein, when said cap rolls on said cutting device, said cutting edge of said at least one second blade is closer to said rotation axis than said second abutting surface so that said second blade completely penetrates a thickness of said cap without contacting said second external face of said receiving hollow portion.

5. Cutting apparatus according to any one of claims 2 to 4, wherein, when said cap rolls on said cutting device, a cutting edge of said cutting arrangement is closer to said rotation axis than said first abutting surface and/or than said second abutting surface so that said cutting edge of said cutting arrangement means completely penetrates a thickness of said cap without contacting said intermediate external face of said receiving hollow portion.

6. Cutting apparatus according to claim 1, wherein a diameter of said receiving hollow portion is less than a diameter of said at least one abutting surface.

7. Cutting apparatus according to claim 1, wherein said receiving hollow portion includes a single groove configured to receive at least partially said first blade said second blade and said cutting device.

8. Cutting apparatus for cutting a cap, comprising:
an advancement path travelable by said cap;
a cutting zone arranged on said advancement path;
a cutting device arranged in said cutting zone for cutting said cap, said cutting device comprising:
at least one first blade which is horizontal and which is configured to make one or more circumferential cuts on said cap;
at least one second blade which is horizontal and which is configured to make one or more circumferential cuts on said cap, said at least one first blade and said at least one second blade being vertically spaced from each other;
a cutting arrangement with one or more vertical and/or oblique blades configured to make one or more vertical and/or oblique cuts on said cap, said cutting arrangement being arranged in a zone vertically comprised between said at least one first blade and said at least one second blade;
a spindle which is movable along said advancement path to feed said cap to said cutting zone and which is rotatable around a rotation axis, said spindle comprising an engaging portion which is rotatable around said rotation axis and which is configured to engage an inner portion of said cap, said cap rolling on said cutting device to make said cuts when said spindle reaches said cutting zone, said engaging portion comprising:
at least one abutting surface which is circumferential and which is arranged for contacting an inner portion of said cap;
at least one first groove which is circumferential and which is configured so that, when said cap rolls on said cutting device, said first blade is at least partially received into said first groove keeping a first distance between a bottom of said first groove and a cutting edge of said first blade so as to avoid a contact between said bottom and said cutting edge;
at least one second groove which is circumferential and which is vertically spaced from said first groove and which is configured so that, when said cap rolls on said cutting device, said second blade is at least partially received into said second groove keeping a second distance between a bottom of said second groove and a cutting edge of said second blade so as to avoid a contact between said bottom and said cutting edge;
at least one intermediate portion which is circumferential and which is arranged between said at least one first groove and said at least one second groove, said at least one intermediate portion being configured so that, when said cap rolls on said cutting device, said cutting arrangement is facing said intermediate portion keeping a third distance between an external surface of said intermediate portion and said cutting arrangement so as to avoid a contact between said external surface and said cutting arrangement.

9. Cutting apparatus according to claim 8, wherein said at least one abutting surface includes a first abutting surface and a second abutting surface, said first abutting surface and said second abutting surface being vertically spaced, said first groove and said second groove being vertically arranged between said first abutting surface and said second abutting surface; and wherein, when said cap rolls on said cutting device, said cutting edge of said at least one blade is closer to said rotation axis than said first abutting surface so that said first blade completely penetrates a thickness of said cap without contacting said bottom of said first groove.

10. Cutting apparatus according to claim 9, wherein, when said cap rolls on said cutting device, said cutting edge of said at least one second blade is closer to said rotation axis than said second abutting surface so that said second blade completely penetrates a thickness of said cap without contacting said bottom of said second groove-.

11. Cutting apparatus according to claim 9, wherein, when said cap rolls on said cutting device, a cutting edge of said cutting arrangement is closer to said rotation axis than said first abutting surface and/or than said second abutting surface so that said cutting edge of said cutting arrangement completely penetrates a thickness of said cap without contacting said external surface of said intermediate portion.

12. Cutting apparatus according to claim 1, wherein a diameter of said bottom of said first groove is less than a diameter of said at least one abutting surface.

13. Cutting apparatus according to claim 1, wherein a diameter of said bottom of said second groove is less than a diameter of said at least one abutting surface.

14. Cutting apparatus according to claim 1, wherein a diameter of said intermediate portion is less than a diameter of said at least one abutting surface.

15. Cutting apparatus according to claim 1, wherein, when said cap rolls on said cutting device, a difference between half a diameter of said at least one abutting surface and half a diameter of said intermediate portion is more than double, or triple, of said third distance; in particular, said third distance is within a range from 0.02 mm to 0.20 mm.

16. Cutting apparatus according to claim 1, comprising a first adjustment device configured to vary a position of said cutting device along a direction transverse with respect to said advancement path so as to move closer or move away said cutting device with respect to said advancement path, in order to adjust said first distance, second distance and third distance.

17. Cutting apparatus according to claim 1, comprising a second adjustment device means configured to vary a position of said first blade and said second blade independently from said cutting arrangement along a direction transverse with respect to said advancement path, so as to move closer or move away said first blade and said second blade with respect to said advancement path, in order to adjust said first distance and second distance.

18. Cutting apparatus according to claim 17, wherein said second adjustment device is configured to vary a mutual position between said first blade and said second blade along a direction transverse with respect to said advancement path, so as to move closer or move away said first blade and second blade with respect to said advancement path independently from each other, in order to adjust said first distance (independently from said second distance end vice versa.

19. Cutting apparatus according to claim 1, comprising a third adjustment device configured to vary a mutual position between said cutting arrangement and said first blade and second blade along a direction transverse with respect to said advancement path, so as to move closer or move away said cutting arrangement with respect to said advancement path independently from said first blade and second blade, in order to adjust said third distance independently from said first distance and second distance.

20. Cutting apparatus according to claim 16, wherein said first adjustment device and/or said second adjustment device and/or said third adjustment device includes at least one micrometric screw.

21. Cutting apparatus according to claim 1, wherein, when said cap rolls on said cutting device, said cutting arrangement protrudes from a lateral wall of said cap towards said rotation axis for an exceeding distance selected on the basis of a thickness of said lateral wall; in particular, said exceeding distance is from 10% to 40% of said thickness of said lateral wall.

22. Cutting apparatus according to claim 21, wherein said first blade and/or said second blade protrude(s) from said lateral wall of said cap towards said rotation axis for a further exceeding distance selected on the basis of said exceeding distance; in particular, said further exceeding distance is from 120% to 250% of said exceeding distance.

23. Method for cutting a cap, in particular implemented by a cutting apparatus according to claim 1, comprising the steps of:
feeding a cap along an advancement path to a cutting zone where a cutting device is arranged;
engaging said cap with an engaging portion of a spindle;
rolling said cap on said cutting device;
during said rolling, making one or more circumferential cuts on said cap by means of at least one first blade of said cutting device, one or more circumferential cuts on said cap by means of at least one second blade of said cutting device spaced from said first blade, and one or more vertical and/or oblique cuts on said cap by means of a cutting arrangement arranged in a zone between said at least one first blade and said at least one second blade;
wherein, during said rolling:
said first blade is at least partially received into a receiving hollow portion which is circumferential and which is obtained on said engaging portion keeping a first distance between a first external face of said receiving hollow portion and a cutting edge of said first blade so as to avoid a contact between said first external face and said cutting edge;
said second blade is at least partially received into said receiving hollow portion keeping a second distance between a second external face of said receiving hollow portion and a cutting edge of said second blade so as to avoid a contact between said second external face and said cutting edge;
said cutting arrangement is at least partially received into said receiving hollow portion keeping a third distance between an external intermediate face of said receiving hollow portion so as to avoid a contact between said external intermediate face and said cutting arrangement, said external intermediate face being interposed between said first external face and said second external face.

24. Method for cutting a cap, in particular implemented by a cutting apparatus according to claim 8, comprising the steps of:
feeding a cap along an advancement path to a cutting zone where a cutting device is arranged;
engaging said cap with an engaging portion of a spindle;
rolling said cap on said cutting device;
during said rolling, making one or more circumferential cuts on said cap by means of at least one first blade of said cutting device, one or more circumferential cuts on said cap by means of at least one second blade of said cutting device spaced from said first blade, and one or more vertical and/or oblique cuts on said cap by means of a cutting arrangement arranged in a zone between said at least one first blade and said at least one second blade;
wherein, during said rolling:
said first blade is at least partially received into a first groove which is circumferential and which is obtained on said engaging portion keeping a first distance between a bottom of said first groove and a cutting edge of said first blade so as to avoid a contact between said bottom and said cutting edge;
said second blade is at least partially received into a second groove which is circumferential and which is obtained on said engaging portion keeping a second distance between a bottom of said second groove and a cutting edge of said second blade so as to avoid a contact between said bottom and said cutting edge;
said cutting arrangement is facing an intermediate portion which is circumferential of said engaging portion and which is arranged between said first groove and said second groove, keeping a third distance between an external surface of said intermediate portion and said cutting arrangement so as to avoid a contact between said external surface and said cutting arrangement.
